(19) United States
(12) Patent Application Publication
(10) Pub. No.: US 2015/0112887 A1
(43) Pub. Date: Apr. 23, 2015

(54) LOCKER DROP OFF

(71) Applicant: Roy Leon Camp, Fresno, CA (US)

(72) Inventor: Roy Leon Camp, Fresno, CA (US)

(21) Appl. No.: 14/056,466

(22) Filed: Oct. 17, 2013

(51) Int. Cl. G06Q 10/08

(52) U.S. Cl. CPC G06Q 10/0836; G06Q 10/0837
USPC 705/339

(57) ABSTRACT

A system and method for dropping off an item at a locker are described. A locker is identified based on a size of an item and a geographic location of a seller of the item listed in an online marketplace. A lock code and an unlock code for the locker are generated. The locker is locked closed in response to receiving the lock code at the locker and is opened in response to receiving the unlock code at the locker. The lock code is communicated along with a location of the locker to the seller of the item.

### TECHNICAL FIELD

This application relates generally to the field of computer technology and, in a specific example embodiment, to a method and system for shipping an item.

### BACKGROUND

Online marketplaces include many sellers listing items for sale. Buyers buy these items and sellers ship the items to the buyer upon receipt of payment. The shipping process typically includes the seller packing the item in a box, sealing it up, bringing it to the post office, filling out the necessary forms, weighing it to calculate the postage, paying for the postage, affixing the stamp on the box, and finally dropping the box in the parcel deposit area. Because this inefficient shipping process entails many steps, it becomes a deterrent for sellers to list, sell, and ship their items.

### BRIEF DESCRIPTION OF THE DRAWINGS

The present disclosure is illustrated by way of example, and not by way of limitation, in the figures of the accompanying drawings in which:

FIG. 1 is a network diagram depicting a network system having a client-server architecture configured for exchanging data over a network, according to one embodiment.

FIG. 2 shows a block diagram illustrating one example embodiment of a marketplace application.

FIG. 3 shows a block diagram illustrating one example embodiment of a locker drop off application.

FIG. 4 shows a block diagram illustrating another example embodiment of a locker drop off application.

FIG. 5 shows a block diagram illustrating one example embodiment of an operation of a locker drop off system to ship an item.

FIG. 6 shows a block diagram illustrating one example embodiment of an operation of a locker drop off system to return an item.

FIG. 7 shows a block diagram illustrating one example embodiment of an operation of a locker drop off system to drop off an item for a local buyer.

FIG. 8 shows a block diagram illustrating one example embodiment of an operation of a locker drop off system to return an item from a local buyer.

FIG. 9 shows a ladder diagram illustrating one example embodiment of an operation of a locker drop off system.

FIG. 10 shows a ladder diagram illustrating one example embodiment of an operation of a locker drop off system for a local buyer.

FIG. 11 shows a flow diagram illustrating one example embodiment of a method for operating a locker drop off system.

FIG. 12 shows a flow diagram illustrating another example embodiment of a method for operating a locker drop off system.

FIG. 13 shows a flow diagram illustrating another example embodiment of a method for operating a locker drop off system.

FIG. 14 shows a diagrammatic representation of machine, in the example form of a computer system, within which a set of instructions may be executed to cause the machine to perform any one or more of the methodologies discussed herein.

### DETAILED DESCRIPTION

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for dropping off an item at a locker are described. A locker is identified based on an identification of an item and a geographic location of a seller of the item listed in an online marketplace. A lock code and an unlock code for the locker are generated. The locker becomes locked in response to receiving the lock code at the locker and opens in response to receiving the unlock code at the locker. The lock code, the geographical location of the locker, and an identification of the locker are communicated to the seller of the item.

### System Architecture

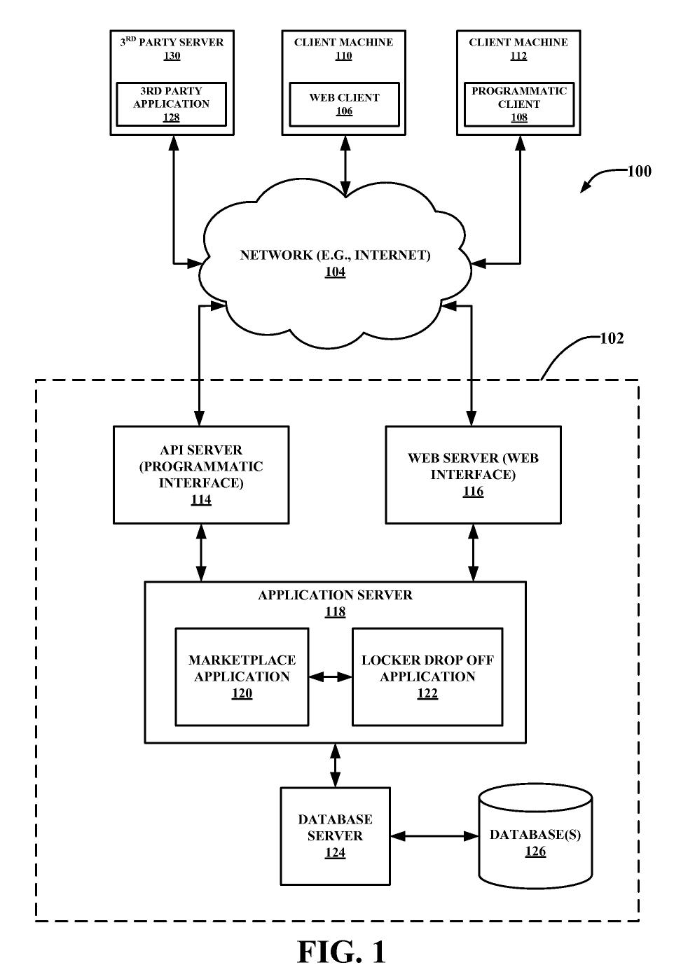

FIG. 1 is a network diagram depicting a network system 100 having a client-server architecture configured for exchanging data over a network, according to one embodiment. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture, other embodiments may include other network architectures, such as peer-to-peer or distributed network environments.

A data exchange platform, in an example form of a marketplace application 120 and a locker drop off application 122, may provide server-side functionality, via a network 104 (e.g., the Internet) to one or more clients. The one or more clients may include users that utilize the network system 100 and, more specifically, the marketplace application 120 and the locker drop off application 122, to exchange data over the network 104. These transactions may include transmitting, receiving (communicating), and processing data to, from, and regarding content and users of the network system 100. The data may include, but is not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data, such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, each in communication with the networked system 102 and optionally each other. The buyers and sellers may be any one of individuals, merchants, or service providers.

Turning specifically to the marketplace application 120 and the locker drop off application 122, an application program interface (API) server 114 and a web server 116 are coupled to, and provide programmatic and web interfaces respectively to, one or more application servers 118. The application server 118 hosts one or more marketplace applications 120 and one or more locker drop off applications 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the locker drop off application 122 includes a system and a method for identifying a locker, and generating a code to lock and a code to unlock to a seller of the marketplace application 120. The location and size of the locker may be based on the size of the item sold from the seller and the geographic location of the seller. In one embodiment, the locker drop off application 122 includes a system and a method for generating a shipping label for a shipping carrier, and for communicating the code to unlock to the shipping carrier corresponding to the shipping label. The shipping carrier accesses the item in the locker using the code to unlock and packages the item if the item is not disposed in a shipping package. The shipping label is then affixed to the shipping package. The shipping carrier ships the item to the buyer identified in the shipping label.

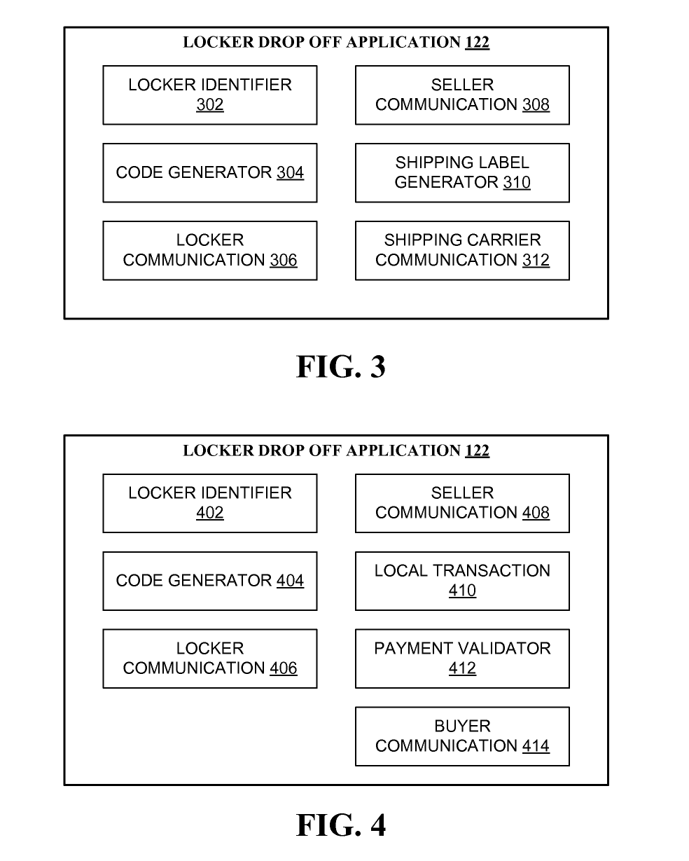

In another embodiment, the locker drop off application 122 determines whether the geographical distance between the buyer and the seller is within a distance threshold. For example, if the locker drop off application 122 determines that the buyer and seller of the item are within 10 miles of each other, the locker drop off application 122 may identify a locker that is located half way between the seller and the buyer. In another embodiment, the locker drop off application 122 may identify an available locker that is located closer to the seller or buyer based on a number of factors such as reputation or ranking of seller/buyer, date/time of sale, number of lockers available between the residence/business location of the seller/buyer, and dynamic GPS location of a mobile device of the seller/buyer. The locker drop off application 122 is described in more detail below with respect to FIG. 3.

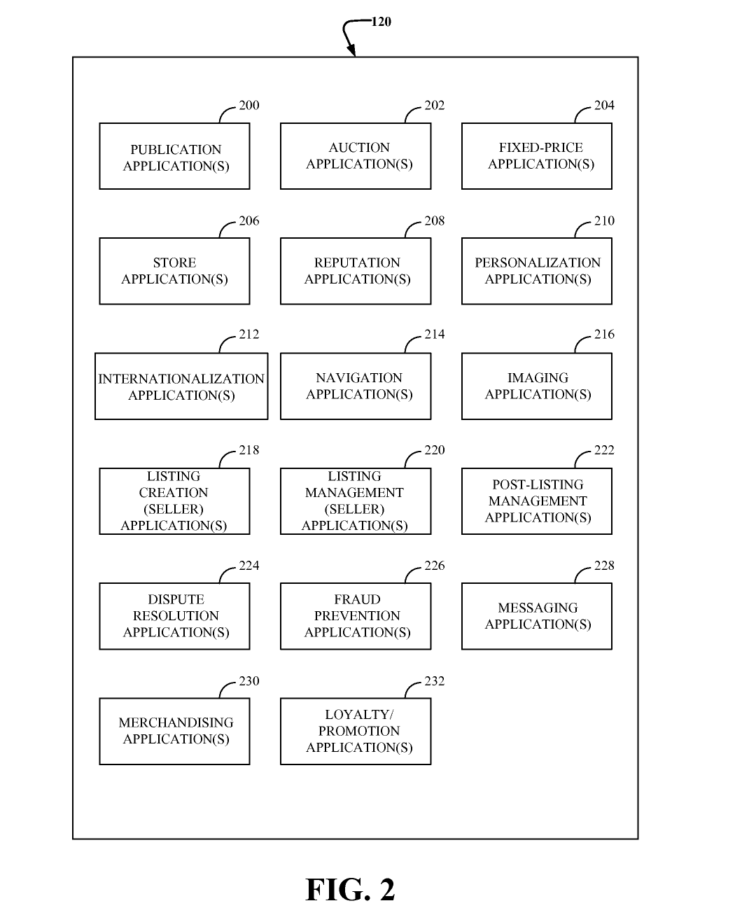

FIG. 2 shows a block diagram illustrating one example embodiment of the marketplace application 120. The marketplace application 120 may be hosted on dedicated or shared server machines (not shown) that are communicatively coupled to enable communications between server machines. The marketplace application 120 and the locker drop off application 122 themselves are communicatively coupled (e.g., via appropriate interfaces) to each other and to various data sources, so as to allow information to be passed between the marketplace application 120 and the locker drop off application 122 or so as to allow the marketplace application 120 and the locker drop off application 122 to share and access common data. The marketplace application 120 and the locker drop off application 122 may, furthermore, access one or more databases 126 via the database servers 124.

The networked system 102 may provide a number of publishing, listing, and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page in which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace application 120 and the locker drop off application 122 may include one or more imaging applications 216, which users may utilize to upload images for inclusion within the listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the locker drop off application 122. The locker drop off application 122 may include a locker identifier module 302, a code generator module 304, a locker communication module 306, a seller communication module 308, a shipping label generator module 310, and a shipping carrier communication module 312.

The locker identifier module 302 identifies a geographically static container, such as a physical locker based on an item (e.g., physical dimensions or size of the item, value of the item) and a geographic location of a seller of the item listed in the marketplace application 120. For example, the locker identifier module 302 may identify the address of a store or facility where the physical locker is located. Because the store or facility may include many physical lockers, the locker identifier module 302 may further identify the particular locker at the store using an identifier (e.g., locker 123 at 456 Main St.). It is noted that the locker identifier module 302 identifies lockers that are unlocked and available to receive the item at the time of request from the seller.

In another embodiment, the locker identifier module 302 identifies a locker based on other factors such as locker availability, the ranking or reputation of the seller in the marketplace application 120, the time of listing from the seller, and whether the seller has requested for a special sized locker. For example, the locker identifier module 302 may provide the seller with a list of facilities with available lockers within x miles of the home or work address of the seller. In response, the seller may select only particular facilities or store chains. For example, the locker identifier module 302 may identify available lockers only from store chain A located within x miles of the seller.

In another example, the locker identifier module 302 scans a database of available lockers (e.g., unlocked) that are geographically located within a radius of x miles of the seller and that are in a facility or store that is opened 24 hours.

In another example, the locker identifier module 302 identifies the physical dimensions of the item based on an identification of the item from the seller. The locker identifier module 302 then determines available lockers with sizes large enough to fit the item based on the physical dimensions of the item.

In another example, the locker identifier module 302 may request, from the seller, the physical dimensions of the item or the physical dimensions of a package used to ship the item. The locker identifier module 302 then determines available lockers with sizes large enough to fit the item based on the physical dimensions of the item or based on the physical dimensions of the package.

The code generator module 304 generates a lock code and an unlock code for the locker identified by the locker identifier module 302. The locker may close or become locked in response to receiving the lock code. The locker may open or become unlocked in response to receiving the unlock code.

In one embodiment, the locker receives the lock code and the unlock codes via a keypad located near the locker. The seller may input the lock code using the keypad located near the locker. In another embodiment, the locker may receive the lock code remotely from a mobile device of the seller. For example, the seller may activate the lock code on his mobile device when in proximity to the locker. The mobile device may communicate indirectly with the locker to activate the locking via a computer network (e.g., Internet). For example, the mobile device of the seller may communicate the lock code (e.g., that is unique to every locker and valid for a one time usage) to a server in communication with the locker. After the server validates the lock code from the mobile device, the server instructs the locker to lock accordingly. In another embodiment, the mobile device of the seller may communicate directly with the locker via infrared, Wi-Fi, Bluetooth, NFC, or any other wireless means and send the lock code directly to the locker.

Similarly, a delivery person from a shipping carrier may manually enter the unlock code on the keypad of the locker to unlock the locker and access the item. The delivery person may, similarly, use a communication device to communicate the unlock code directly or indirectly to the locker to unlock the locker.

In one embodiment, the code generator module 304 generates lock codes and unlock codes that are unique and expire within a predefined amount of time from the time they are generated. For example, a lock code, if not used within a day, may become void and can no longer be used to lock a locker.

In another embodiment, the code generator module 304 may access a unique identifier to the seller. The unique identifier may be used to lock and unlock the locker. The unique identifier includes a random token generated by the code generator module 304 or may be based on biometric features of the seller, and unique information of the seller such as the seller's driver's license number or social security number.

The locker communication module 306 may communicate the unique identifier or unique information to the locker (corresponding to the locker identified by the locker identifier module 302) so that when the locker receives the unique identifier, the locker operates to be locked or unlocked accordingly (e.g., doors may open or close automatically, a lock on the corresponding locker door may be activated or deactivated). In one embodiment, the locker communication module 306 sends locking data (e.g., lock code, unlock code, seller information, shipping carrier information, among others). For example, the locker communication module 306 may send information data from the driver's license of the seller or a credit card of the seller. The seller may only have to swipe his driver's license or credit card at a device connected to the locker to lock or unlock it without having to enter any code on any keypad of the locker.

The locker communication module 306 may receive status data regarding a status of the locker. For example, the status data may indicate whether the locker is opened or closed, whether a sensor inside the locker detects an item inside it, whether a locker of the locker is activated or deactivated, the time and date the locker was activated, the time and date the locker was locked or unlocked, the information received at the locker (e.g, code entered, magnetic bar code from an ID or a credit card). In one embodiment, the locker communication module 306 receives the lock or unlock code from the locker and determines the validity of the lock or unlock code. In another embodiment, the validation of the lock code or unlock code is performed at the locker instead of at the locker drop off application 122. For example, the locker communication module 306 does not receive the lock or unlock code from the locker, but only receives an indication of whether the locker has been opened or closed.

The seller communication module 308 communicates the information of the locker to the seller in response to the seller requesting to drop off an item for sale at a locker. For example, the information may include the geographic location of the locker (e.g., store ABC at 123 main st.), an identification of the locker (e.g., locker A2), and a lock code to lock the corresponding locker (or an unlock code to open the locker door).

In another embodiment, the seller communication module 308 receives information of the item from the seller. For example, the information may include an identification of the item (e.g., digital player brand x model y), the physical dimensions of the item (e.g., size of the actual item or package containing the item), value of the item (e.g., sell price), and so forth.

The shipping label generator 310 may generate a shipping label for a shipping carrier based on the size and weight of the item, the address of the buyer, the type of shipping service selected by the seller (e.g., overnight, express, saver, ground), the value of the item, and whether the item is insured for shipping. The shipping label generator 310 may communicate with a shipping carrier server (not shown) to generate the shipping label and a tracking number.

The shipping carrier communication module 312 communicates the information of the locker to the shipping carrier. For example, the information may include the geographic location of the locker (e.g., store ABC at 123 main st.), an identification of the locker (e.g., locker A2), and an unlock code to unlock the corresponding locker.

The shipping carrier communication module 312 may also receive information from the shipping label generator module 310 to generate the shipping label. The shipping carrier may then affix the shipping label to the item from the locker. In another embodiment, the shipping carrier communication module 312 may receive the shipping label from the shipping carrier communication module 312 and affix the label to the item from the locker.

In another embodiment, the shipping carrier communication module 312 may also receive information of the item. The shipping carrier may identify a box that is large enough to accommodate the item.

FIG. 4 shows a block diagram illustrating another example embodiment of the locker drop off application 122. The locker drop off application 122 may include a locker identifier module 402, a code generator module 404, a locker communication module 406, a seller communication module 408, a local transaction module 410, a payment validator module 412, and a buyer communication module 414.

The local transaction module 410 identifies the address of the buyer and the seller and determines whether the distance between them is less than a distance threshold (e.g., 20 miles). If the local transaction module 410 determines that the seller is close enough to the buyer, the locker identifier module 402 may identify an available locker that is geographically located between the seller and the buyer. The distance between the available locker and the seller and the distance between the available locker and the buyer may be approximately the same. In another example, the locker may be located closer to the address of the seller if the seller is relatively ranked high in the online marketplace. In another example, the locker may be located closer to the address of the buyer if the buyer pays an additional fee or a convenience fee in the online marketplace. In another example, the locker may be located closer to the address of the buyer if the buyer's ranking is relatively high in the online marketplace.

The code generator module 404 may operate similarly to the code generator module 304 of FIG. 3. The locker communication module 406 may operate similarly to the locker communication module 306. The seller communication module 408 may operate similarly to seller communication module 308.

The payment validator module 412 may verify that the online marketplace has received and processed a payment from the buyer. Upon validation of the payment, the buyer communication module 414 sends information of the locker to the buyer. For example, the information may include the geographic location of the locker (e.g., store ABC at 123 main st.), an identification of the locker (e.g., locker A2), and an unlock code to unlock the corresponding locker.

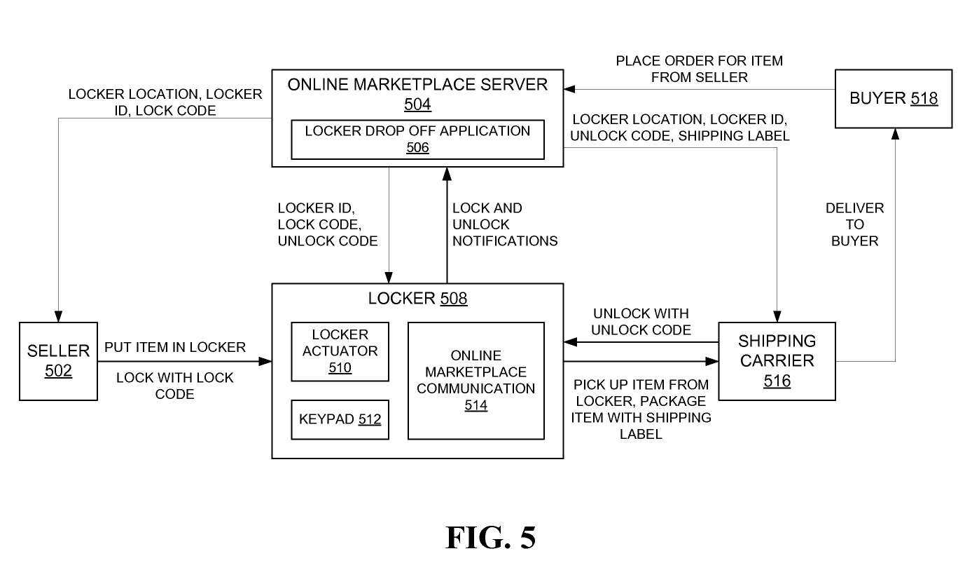

FIG. 5 shows a block diagram illustrating one example embodiment of an operation of a locker drop off system to ship an item. A seller 502 may list an item for sale with the online marketplace server 504. The seller 502 may communicate information about the item (e.g., model, size, weight) to the online marketplace server 504. The online marketplace server 504 may receive an order for the item from a buyer 518.

The locker drop off application 506 of the online marketplace server 504 receives the information from the seller 502 and identifies an available locker that is geographically located in proximity to address of the seller 502 (e.g., home, work, or other). The locker drop off application 506 identifies the item and determines a shipping carrier to process the shipping of the item. In one embodiment, the locker drop off application 506 generates a locker identifier, a lock code, and an unlock code. The locker identifier may include a geographic location of the locker and an identification of the locker.

The locker drop off application 506 communicates the locker identifier, the lock code, the unlock code to the locker 508. In one embodiment, the locker drop off application 506 communicates a location of the locker, the locker identifier, and a lock code to the seller 502. The lock code allows the seller 502 to lock the item and the corresponding locker.

In one embodiment, the locker 508 includes a locker actuator 510, a keypad 512, and an online marketplace communication module 514. The seller 502 puts the item in the corresponding locker 508 and enters the lock code into the keypad 512 of the locker 508. In response to the lock code, the locker actuator 510 locks a door of the locker 508. The online marketplace communication module 514 may be configured to communicate with the locker drop off application 506. For example, the online marketplace communication module 514 receives the lock code, the unlock code, and an identification of the locker 508. In one embodiment, the online marketplace communication module 514 notifies the locker drop off application 506 of the status of the locker actuator 510. For example, the online marketplace communication module 514 may notify the locker drop off application 506 of the time and date when the locker 508 has been locked and unlocked.

The locker drop off application 506 also communicates the location of the locker 508, the locker identifier, the unlock code, and item information to the corresponding shipping carrier 516. A carrier from the shipping carrier 516 may retrieve the item from the locker 508 by entering the unlock code into the keypad 512 from the corresponding locker 508. In one embodiment, the shipping carrier 516 packages the item with a container having a size based on the item information.

In one embodiment, the locker drop off application 506 also generates a shipping label for the shipping carrier 516. The shipping carrier 516 may affix the shipping label, received from the locker drop off application 506, to the container.

The shipping carrier 516 may process and deliver the package or container to the buyer 518 according to the shipping service specified on the shipping label.

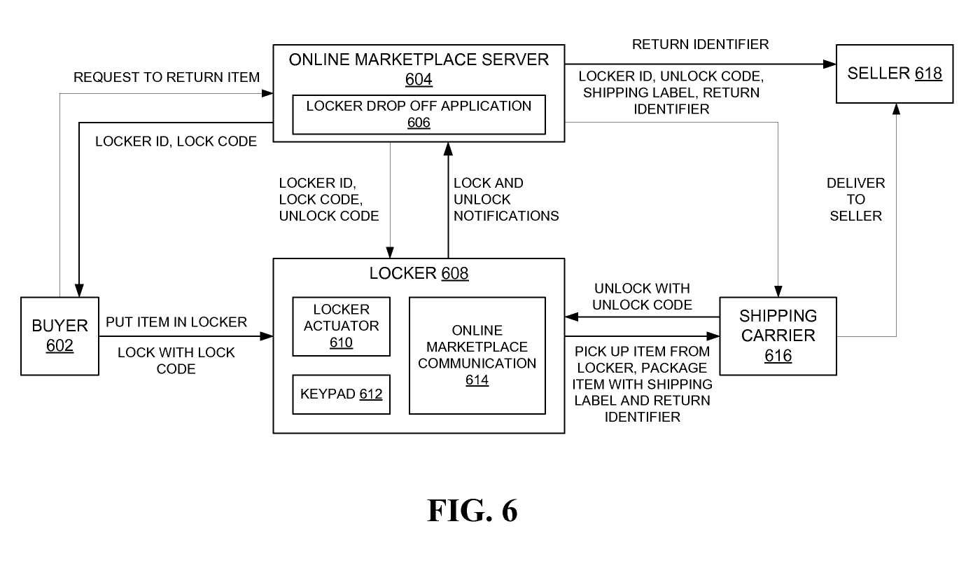

FIG. 6 shows a block diagram illustrating one example embodiment of an operation of a locker drop off system to return an item. The buyer 602 may submit a request to the online marketplace server 604 to return an item that was sold by a seller 618 on the online marketplace server 604. The locker drop off application 606 may identify an available locker 608 that is geographically in proximity to the address off the buyer 602. The locker 608 may include a locker actuator 610, a keypad 612, and an online marketplace communication module 614. The locker drop off application 606 may communicate a location of the locker 608, a locker identifier, and a lock code.

The buyer 602 puts the item in the corresponding locker 608 and locks it in the locker 608 with the lock code provided from the locker drop off application 606. In one embodiment, the buyer 602 enters the lock code on the keypad 612. In response to validating the lock code, the locker actuator 610 locks the locker 608. The online marketplace communication module 614 may generate a notification to the locker drop off application 606 that the locker 608 has been locked.

The shipping carrier 616 receives a shipping label, a location off the locker 608, an unlock code, and a return identifier. The locker drop off applications 606 also communicates the return identifier to the seller 618. The shipping carrier 616 may unlock the locker 608 by entering the unlock code on the keypad 612. The shipping carrier 616 then picks up the item from the locker 608 and packages the item with the shipping label and return identifier received from the locker drop off application 606. The shipping carrier 616 then processes the shipping and delivers the item to the seller 618.

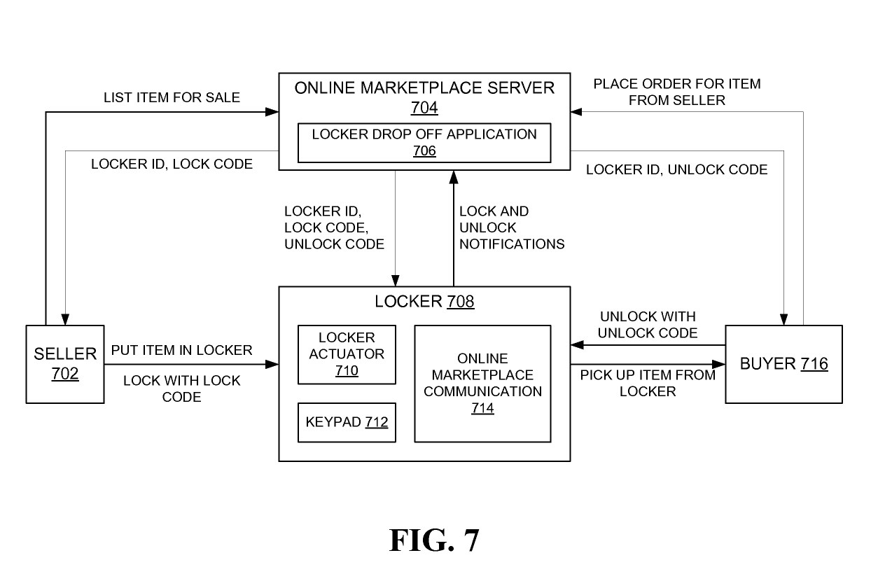

FIG. 7 shows a block diagram illustrating one example embodiment of an operation of a locker drop off system to drop off an item for a local buyer. A seller 702 may list an item for sale on the online marketplace server 704. The online marketplace server 704 also receives an order for the same item from a buyer 716.

The locker drop off application 706 determines the distance between the seller 702 and the buyer 716. If the distance between the seller 702 and the buyer 716 is less than a threshold distance, the locker drop off application 706 may determine that the transaction between the buyer 716 and the seller 702 is a local transaction. The locker drop off application 706 identifies a locker 708 that is geographically in proximity to both the seller 702 and the buyer 716. For example, the locker 708 may be located at a same distance between the seller 702 and the buyer 716.

The locker 708 may include a locker actuator 710, a keypad 712, and an online marketplace communication 714 module. The seller 702 receives information of the locker 708. The information may include a geographic location off the locker 708, a locker identifier, and a lock code. The seller 702 may put the item in the locker 708 without any packaging material and secure a door of the locker 708 using the lock code. The online marketplace communication module 714 may notify the locker drop off application 706 of the status of the locker 708 (e.g., closed and locked, closed and unlocked, opened and unlocked, opened and locked).

The locker drop off application 706 may communicate a location of the locker 708, the locker identifier, and the unlock code to the buyer 716. The buyer 716 may retrieve the item from the locker 708 using the unlock code provided by the locker drop off application 706.

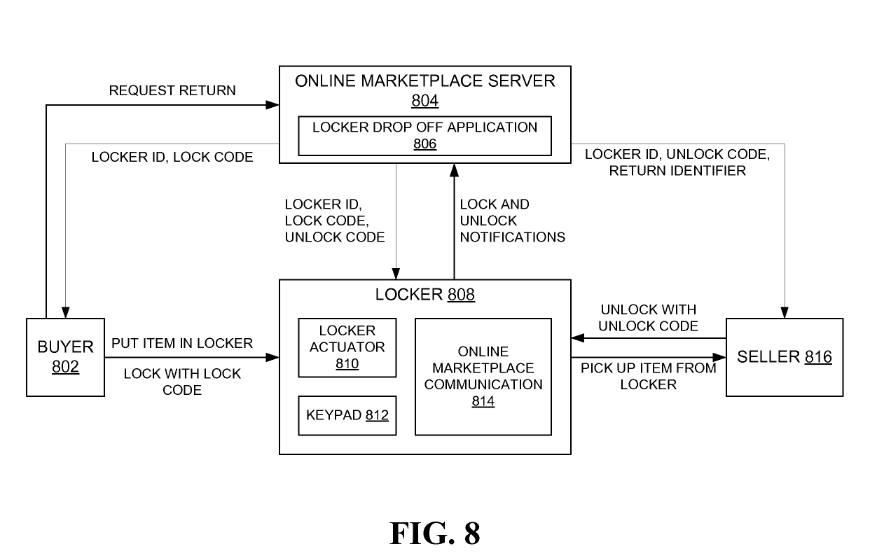

FIG. 8 shows a block diagram illustrating one example embodiment of an operation of a locker drop off system to return an item from a local buyer. A buyer 802 may submit a request to an online marketplace server 804 to return an item back to a seller 816.

The locker drop off application 806 determines the distance between the seller 816 and the buyer 802. If the distance between the seller 816 and the buyer 802 is less than a threshold distance, the locker drop off application 806 may determine that the transaction between the buyer 802 and the seller 816 is a local transaction. The locker drop off application 806 identifies a locker 808 that is geographically in proximity to both the seller 816 and the buyer 802. For example, the locker 808 may be located at a same distance between the seller 816 and the buyer 802.

The locker 808 may include a locker actuator 810, a keypad 812, and an online marketplace communication module 814. The buyer 802 receives information of the locker 808. The information may include a geographic location off the locker 808, a locker identifier, and a lock code. The buyer 802 may put the item in the locker 808 without any packaging material and secure a door of the locker 808 using the lock code. The online marketplace communication module 814 may notify the locker drop off application 806 of the status of the locker 808 (e.g., closed and locked, closed and unlocked, opened and unlocked, opened and locked).

The locker drop off application 806 may communicate a location of the locker 808, the locker identifier, the unlock code, and a return identifier to the seller 816. The seller 816 may retrieve the item from the locker 808 using the unlock code provided by the locker drop off application 806.

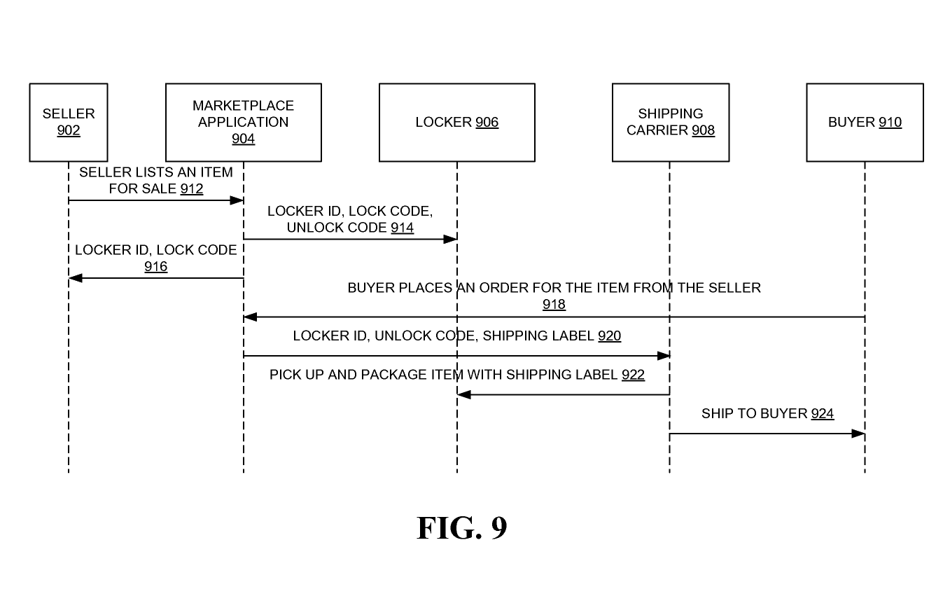

FIG. 9 shows a ladder diagram illustrating one example embodiment of an operation of a locker drop off system. A seller 902 lists an item for sale at operation 912 with a marketplace application 904. At operation 914, the marketplace application 904 identifies a locker 906. The marketplace application 904 communicates the locker identifier, a lock code, and an unlock code to the locker 906. At operation 916, the marketplace application 904 communicates the locker identifier and the lock code to the seller 902. At operation 918, a buyer 910 places an order for the item from the seller 902 on the marketplace application 904. At operation 920, the marketplace application 904 communicates the locker identifier, the unlock code, and a shipping label to the corresponding shipping carrier 908. At operation 922, the shipping carrier 908 picks up the item from the locker 906 and packages the item with the shipping label received from the marketplace application 904. In one embodiment, the shipping carrier 908 may notify the marketplace application 904 that the item has been picked up. In another embodiment, the locker 906 may notify the marketplace application 904 that the item has been picked up by the shipping carrier 908. At operation 924, the shipping carrier 908 processes the package according to the shipping service specified on the shipping label and ships the package to the buyer 910.

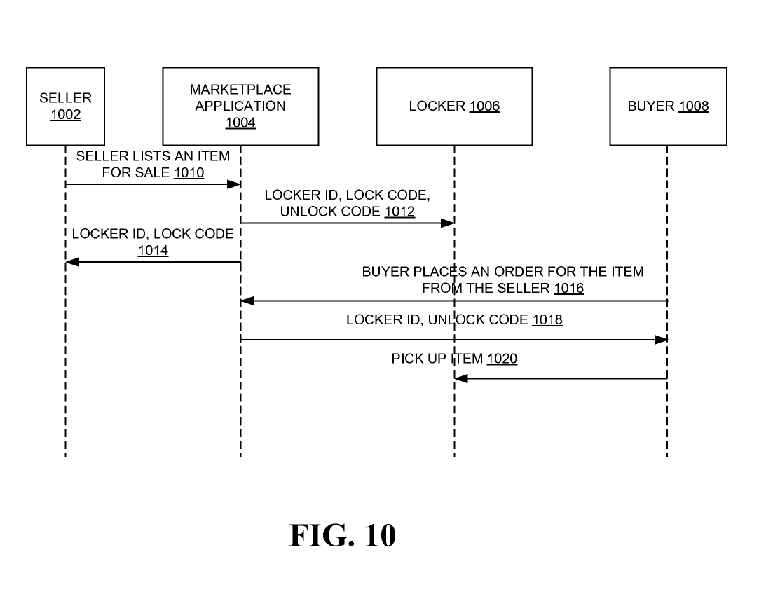

FIG. 10 shows a ladder diagram illustrating one example embodiment of an operation of a locker drop off system for a local buyer. At operation 1010, a seller 1002 lists an item for sale on the marketplace application 1004. At operation 1012, the marketplace application 1004 identifies a locker 1006 and generates a locker identifier, a lock code, and an unlock code. In one embodiment, the marketplace application 1004 identifies the locker 1006 after receiving an order from a buyer 1008. In another embodiment, the marketplace application 1004 identifies the locker 1006 before receiving an order from the buyer 1008.

The marketplace application 1004 may communicate the lock code and unlock code for the corresponding locker identifier to the locker 1006. At operation 1014, the marketplace application 1004 communicates the locker identifier and the lock code to the seller 1002. At operation 1016, the marketplace application 1004 receives an order from a buyer 1008 for the item listed by the seller 1002. In one embodiment, upon validation and verification of the payment from the buyer 1008, the marketplace application 1004 communicates the locker identifier and the unlock code at operation 1018. At operation 1020, the buyer 1008 accesses the item from the locker 1006 using the unlock code and retrieves the item.

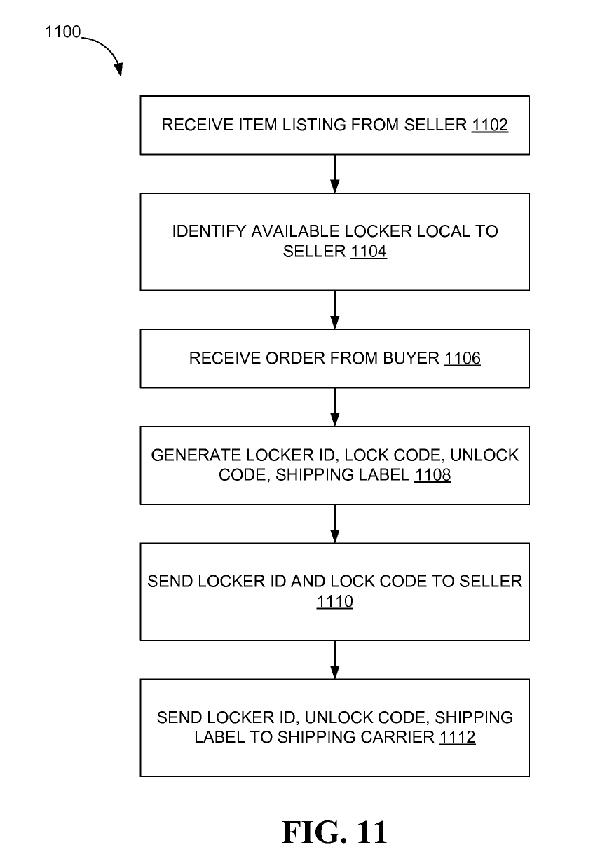

FIG. 11 shows a flow diagram illustrating one example embodiment of a method 1100 for operating a locker drop off system. At operation 1102, an item listing is received from a seller. In one embodiment, this operation may be implemented with the marketplace application 120.

An operation 1104, an available locker located geographically in proximity to the seller is identified. In one embodiment, this operation may be implemented with the locker identifier module 302 of the locker drop off application 122 of FIG. 3.

At operation 1106, an order for the item is received from a buyer. In one embodiment, this operation may be implemented with the marketplace application 120.

At operation 1108, a locker identifier, a lock code, unlock code, and a shipping label corresponding to a shipping carrier are generated. In one embodiment, this operation may be implemented with the code generator module 304 of the locker drop off application 122. In another embodiment, this operation may also be implemented with the locker communication module 306. The locker communication module 306 may communicate the locker identifier, the lock code, and the unlock code to the locker.

An operation 1110, the locker identifier and the lock code are sent to the seller. In one embodiment, this operation may be implemented with the seller communication module 308.

At operation 1112, the locker identifier, the unlock code, and the shipping label are sent to the corresponding shipping carrier. In one embodiment, this operation may be implemented with the shipping carrier communication module 312.

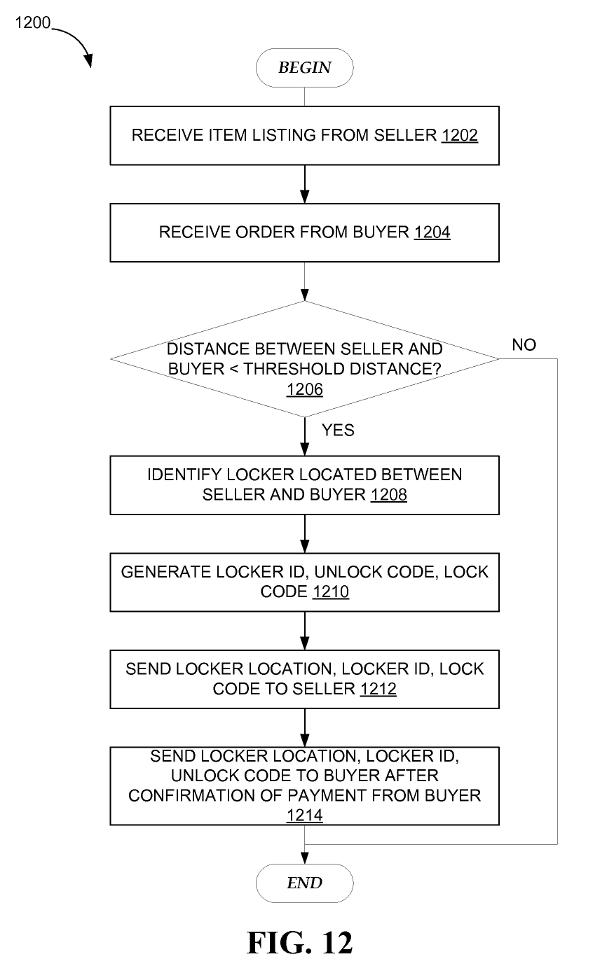

FIG. 12 shows a flow diagram illustrating another example embodiment of a method 1200 for operating a locker drop off system. At operation 1202, an item listing is received from a seller. In one embodiment, this operation may be implemented with the marketplace application 120.

An operation 1204, an order for the item is received from a buyer. In one embodiment, this operation may be implemented with the marketplace application 120.

At operation 1206, the distance between the seller and the buyer is determined and compared to a threshold distance. In one embodiment, this operation may be implemented with the local transaction module 410 of FIG. 4.

If the distance between the seller and the buyer is less then the threshold distance, an available locker local to both the seller and buyer is identified at operation 1208. In one embodiment, this operation may be implemented with the locker identifier module 402 of FIG. 4.

At operation 1210, a locker identifier, a lock code, unlock code are generated. In one embodiment, this operation may be implemented with the code generator module 404. The locker communication module 406 may communicate the locker identifier, the lock code, and the unlock code to the locker.

At operation 1212, the locker identifier and the lock code are sent to the seller. In one embodiment, this operation may be implemented by the seller communication module 408.

At operation 1214, the locker identifier and the unlock code are sent to buyer. In one embodiment, this operation may be implemented with the buyer communication module 414 after verification of payment. The verification of payment from the buyer may be implemented using the payment validator module 412.

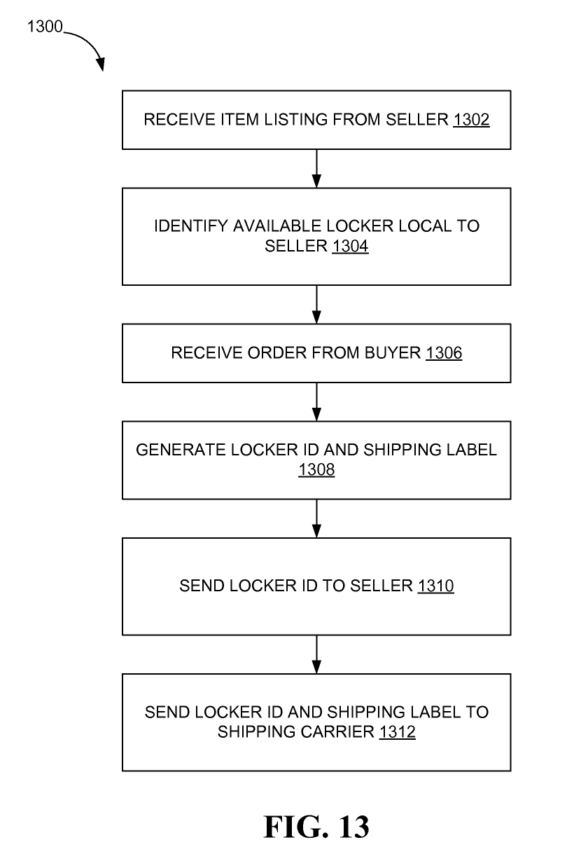

FIG. 13 shows a flow diagram illustrating one example embodiment of a method 1300 for operating a locker drop off system. At operation 1302, an item listing is received from a seller. In one embodiment, this operation may be implemented with the marketplace application 120.

An operation 1304, an available locker located geographically in proximity to the seller is identified. In one embodiment, this operation may be implemented with the locker identifier module 302 of the locker drop off application 122 of FIG. 3.

At operation 1306, an order for the item is received from a buyer. In one embodiment, this operation may be implemented with the marketplace application 120.

At operation 1308, a locker identifier of an available locker is determined. A shipping label corresponding to a shipping carrier is also generated. The shipping label may include a reference to the locker identifier of the available locker. In one embodiment, this operation may be implemented with the code generator module 304 of the locker drop off application 122. In another embodiment, this operation may also be implemented with the locker communication module 306. The locker communication module 306 may communicate the locker identifier to the locker. For example, the locker communication module 306 may tell the locker to operate the identified locker only in response to the seller or a delegate of the seller. For example, the seller may ask his friend to operate the locker on the seller's behalf. The delegation may be revoked by the seller at any time.

An operation 1310, the locker identifier is sent to the seller. In one embodiment, this operation may be implemented with the seller communication module 308. The seller may then operate the locker identified with the locker identifier using a lock code that may include a revocable authentication token of the seller. For example, the revocable authentication token may include credentials entered on a touchscreen at the locker. The credentials may include an alphanumeric code, a username and password related to the online marketplace, or any other authentication token. In another embodiment, the revocable authentication token may include a wireless identifier of a mobile device of the seller so that the locker can operate the locker by waving his mobile device in front of the corresponding locker. The locker may then communicate with the locker drop off application 122 to verify the identity of the seller and validate the authentication token. The locker may operate or lock after receiving a validation from the locker drop off application 122.

At operation 1312, the locker identifier and the shipping label are sent to the corresponding shipping carrier. In one embodiment, this operation may be implemented with the shipping carrier communication module 312. A shipping carrier may have access to the locker using an authentication token (e.g., a shipping carrier identification code or unique code). Similarly, the unlock may be delegated to another party.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below, are set out hardware (e.g., machine) and software architectures that may be deployed in various example embodiments.

### Example Computer System

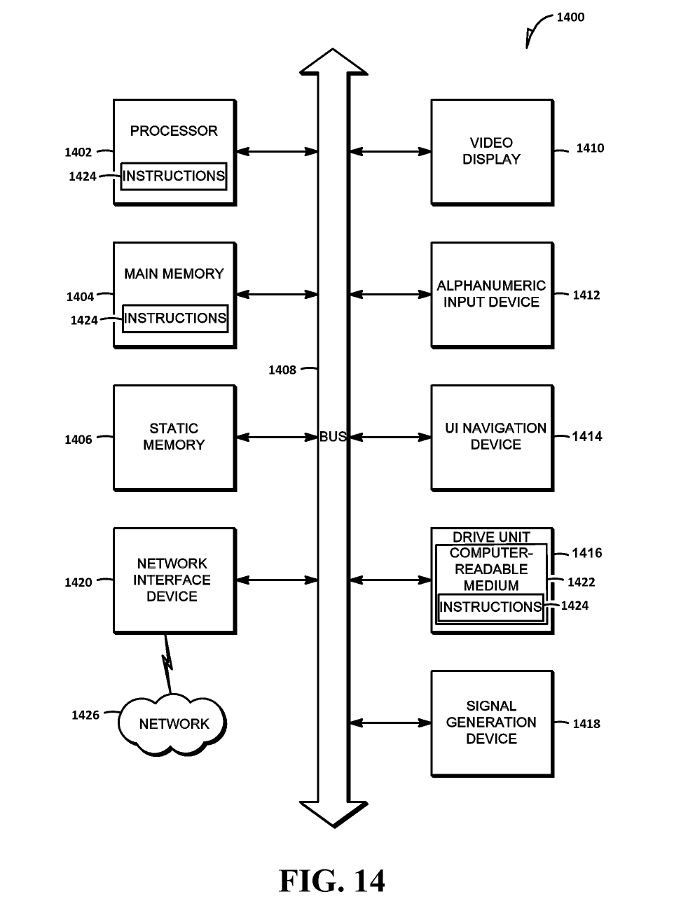

FIG. 14 shows a diagrammatic representation of a machine in the example form of a computer system 1400 within which a set of instructions 1424 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1424 (sequential or otherwise) that specify actions to be taken by that machine. Further, while only a single machine is illustrated, the term “machine” shall also be taken to include any collection of machines that individually or jointly execute a set (or multiple sets) of instructions 1424 to perform any one or more of the methodologies discussed herein.

The example computer system 1400 includes a processor 1402 (e.g., a central processing unit (CPU), a graphics processing unit (GPU, or both)), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a UI navigation device 1414 (e.g., a mouse), a disk drive unit 1416, a signal generation device 1418 (e.g., a speaker), and a network interface device 1420.

The disk drive unit 1416 includes a machine-readable medium 1422 on which is stored one or more sets of instructions and data structures (e.g., software 1424) embodying or utilized by any one or more of the methodologies or functions described herein. The instructions 1424 may also reside, completely or at least partially, within the main memory 1404 and/or within the processor 1402 during execution thereof by the computer system 1400, with the main memory 1404 and the processor 1402 also constituting machine-readable media.

The instructions 1424 may further be transmitted or received over a network 1426 via the network interface device 1420 utilizing any one of a number of well-known transfer protocols (e.g., HTTP).

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions 1424. The term “machine-readable medium” shall also be taken to include any medium that is capable of storing, encoding, or carrying a set of instructions 1424 for execution by the machine and that cause the machine to perform any one or more of the methodologies of the present disclosure, or that is capable of storing, encoding or carrying data structures utilized by or associated with such a set of instructions 1424. The term “machine-readable medium” shall, accordingly, be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A locker drop off system comprising:
a locker identifier module executable by a processor configured to identify a locker based on a size of an item and a geographic location of a seller of the item listed in an online marketplace;
a code generator configured to generate a lock code and an unlock code for the locker, the locker closed in response to receiving the lock code at the locker and opened in response to receiving the unlock code at the locker; and
a seller communication module configured to communicate the lock code with a location of the locker to the seller of the item.

2. The locker drop off system of claim 1, further comprising:
a locker communication module configured to communicate the lock code and the unlock code to the locker, the locker configured to lock the locker in response to receiving the lock code at the locker and to open the locker in response to receiving the unlock code at the locker, the lock code comprising a disposable single use lock code, the unlock code comprising a disposable single use unlock code.

3. The locker drop off system of claim 1, further comprising:
a shipping label generator configured to generate a shipping label corresponding to the item for a shipping carrier; and
a shipping carrier communication module configured to communicate the unlock code with the location of the locker and the shipping label to the shipping carrier.

4. The locker drop off system of claim 1, further comprising:
a local transaction module configured to determine that a distance between the seller and a buyer of the item is within a threshold distance;
the locker identifier module configured to determine the location of the locker to be geographically substantially equidistant between the seller and the buyer when within the threshold distance;
a payment validator configured to validate a payment from the buyer of the item; and
a buyer communication module configured to communicate the unlock code with the location of the locker to the buyer after validating the payment from the buyer.

5. The locker drop off system of claim 4, further comprising:
a buyer communication module configured to receive a request to return the item;
the locker identifier module configured to identify a second locker that is geographically substantially equidistant between the seller and the buyer;
a code generator configured to generate a second lock code and a second unlock code for the second locker, the second locker closed in response to receiving the second lock code at the second locker and opened in response to receiving the second unlock code at the second locker; and
the buyer communication module configured to communicate the second unlock code with a location of the second locker to the buyer.

6. The locker drop off system of claim 1, further comprising:
a buyer communication module configured to receive a request to return the item;
the locker identifier module configured to identify a location of a second locker based on the size of the item and a geographic location of a buyer;
the code generator configured to generate a second lock code and a second unlock code for the second locker, the second locker closed in response to receiving the second lock code at the second locker and opened in response to receiving the second unlock code at the second locker;
a shipping label generator configured to generate a shipping label corresponding to a return of the item for a shipping carrier; and
a shipping carrier communication module configured to communicate the second unlock code with the location of the second locker and the second shipping label to the shipping carrier.

7. The locker drop off system of claim 1, wherein the location of the locker comprises a geographic location and a locker identifier corresponding to the geographic location, a volume of the locker larger than the size of the item.

8. The locker drop off system of claim 1, wherein the locker is configured to receive the item before the item is sold in the online marketplace or without any packaging material or shipping reference related to the online marketplace.

9. The locker drop off system of claim 1, wherein the lock code comprises a revocable authentication token of the seller.

10. The locker drop off system of claim 1, wherein the seller communication module is configured to communicate an order for the item from a buyer to the seller without a mailing address of the seller.

11. A method comprising:
identifying a locker based on a size of an item and a geographic location of a seller of the item listed in an online marketplace;
generating a lock code and an unlock code for the locker, the locker closed in response to receiving the lock code at the locker and opened in response to receiving the unlock code at the locker; and
communicating the lock code with a location of the locker to the seller of the item.

12. The method of claim 11, further comprising:
communicating the lock code and the unlock code to the locker, the locker configured to lock the locker in response to receiving the lock code at the locker and to open the locker in response receiving the unlock code at the locker, the lock code comprising a disposable single use lock code, the unlock code comprising a disposable single use unlock code.

13. The method of claim 11, further comprising:
generating a shipping label corresponding to the item for a shipping carrier; and
communicating the unlock code with the location of the locker and the shipping label to the shipping carrier.

14. The method of claim 11, further comprising:
determining that a distance between the seller and a buyer of the item is within a threshold distance;
determining the location of the locker to be geographically substantially equidistant between the seller and the buyer when within the threshold distance;
validating a payment from the buyer of the item; and
communicating the unlock code with the location of the locker to the buyer after validating the payment from the buyer.

15. The method of claim 14, further comprising:
receiving a request to return the item;
identifying a second locker that is geographically substantially equidistant between the seller and the buyer;
generating a second lock code and a second unlock code for the second locker, the second locker closed in response to receiving the second lock code at the second locker and opened in response to receiving the second unlock code at the second locker; and
communicating the second unlock code with a location of the second locker to the buyer.

16. The method of claim 11, further comprising:
receiving a request to return the item;
identifying a location of a second locker based on the size of the item and a geographic location of a buyer;
generating a second lock code and a second unlock code for the second locker, the second locker closed in response to receiving the second lock code at the second locker and opened in response to receiving the second unlock code at the second locker;
generating a shipping label corresponding to a return of the item for a shipping carrier; and
communicating the second unlock code with the location of the second locker and the second shipping label to the shipping carrier.

17. The method of claim 11, wherein the location of the locker comprises a geographic location and a locker identifier corresponding to the geographic location, a volume of the locker larger than the size of the item.

18. The method of claim 11, further comprising:
communicating an order for the item from a buyer to the seller without a mailing address of the seller,
wherein the locker is configured to receive the item without any packaging material or shipping reference related to the online marketplace.

19. The method of claim 11, wherein the lock code comprises a revocable authentication token of the seller.

20. A non-transitory computer-readable storage medium storing a set of instructions that, when executed by a processor, cause the processor to perform operations, comprising:
identifying a locker based on a size of an item and a geographic location of a seller of the item listed in an online marketplace;
generating a lock code and an unlock code for the locker, the locker closed in response to receiving the lock code at the locker and opened in response to receiving the unlock code at the locker; and
communicating the lock code with a location of the locker to the seller of the item.
